(19) United States
(12) Patent Application Publication
(10) Pub. No.: US 2012/0176382 A1
(43) Pub. Date: Jul. 12, 2012

(54) METHOD FOR CONFIGURING USER INTERFACE SCREEN FOR ELECTRONIC TERMINAL, AND ELECTRONIC TERMINAL FOR CARRYING OUT THE SAME

(76) Inventor: Sang-Gi Noh, Seoul (KR)

(21) Appl. No.: 13/394,311

(22) PCT Filed: Sep. 6, 2010
(86) PCT No.: PCT/KR10/06020

§ 371 Date: Mar. 27, 2012

(30) Foreign Application Priority Data
Sep. 4, 2009 (KR) 10-2009-0083443

(51) Int. Cl. G06T 17/00; G09G 5/00

(52) U.S. Cl. 345/428; 345/660

(57) ABSTRACT

An electronic device terminal comprises a touch recognition unit, a screen display unit, a storage unit and a control unit. The control unit collects window area information for implementing a user interface (UI) screen inputted through the touch recognition unit, responsive to a custom-tailored UI screen requested by a user; displays a window corresponding to the collected window area information on the screen display unit; displays an icon to be displayed in the window on the screen display unit, as setting of the icon to be displayed in the window is requested; displays an icon of an adjusted size on the screen display unit, as setting of a size of the displayed icon is requested; and stores information on the set UI screen in the storage unit. A custom-tailored UI screen is configurable by collecting window area information on partitioned areas defined by a user to configure the UI screen.

### RELATED APPLICATIONS

The present application is a National Phase of International Application Number PCT/KR2010/006020, filed Sep. 6, 2010 and claims priority from, Korean Application Number 10-2009-0083443, filed Sep. 4, 2009.

### TECHNICAL FIELD

The present invention relates to a method of configuring a user interface screen of an electronic device terminal and the electronic device terminal for executing the same, and more specifically, to a method of configuring a custom-tailored user interface screen of an electronic device terminal and the electronic device terminal for executing the same.

### BACKGROUND ART

Generally, in an electronic device terminal such as a navigation terminal of a vehicle or a mobile communication terminal, a user interface (UI) screen such as a menu screen, a standby screen, a list, a player, or a viewer is previously programmed in software as a popup menu, an icon, or a text menu, and thus a user of the electronic device terminal may not change menu configuration or an icon at his or her own will.

That is, in a general electronic device terminal, a user interface (UI) such as a menu screen is allowed to be set only within a range determined by the manufacturer of the electronic device terminal.

In the electronic device terminal, although frequently used menu items are different user by user, only the same menu configuration with a previously defined menu screen configuration is displayed, and it is not allowed to reconfigure a menu or the like to meet requirements of a user.

Therefore, required is a function capable of editing a user interface screen such as a standby screen or a menu screen of an electronic device terminal by a user to the taste of the user.

### DISCLOSURE OF INVENTION

### Technical Problem

Therefore, the present invention has been made in view of the above problems, and it is an object of the present invention to provide a method of configuring a custom-tailored user interface (UI) screen of an electronic device terminal, which can configure the UI screen of the electronic device terminal to the taste of a user. In addition, another object of the present invention is to provide an electronic device terminal having a function of configuring a UI screen, which can configure the UI screen of an electronic device terminal to the taste of a user.

### Technical Solution

To accomplish the above object, according to one aspect of the present invention, there is provided a method of configuring a user interface screen of an electronic device terminal. As implementation of a custom-tailored UI screen is requested, window area information for implementing the user interface (UI) screen is collected in response to a touch of a user. Subsequently, a window corresponding to the collected window area information is displayed. Subsequently, as setting of an icon to be displayed in the window is requested, the icon to be displayed in the window is displayed. Subsequently, as setting of a size of the displayed icon is requested, an icon of an adjusted size is displayed. Subsequently, information on the set UI screen is stored.

According to another aspect of the present invention, there is provided an electronic device terminal, comprising a touch recognition unit, a screen display unit, a storage unit and a control unit. The control unit collects window area information for implementing a user interface (UI) screen inputted through the touch recognition unit, as implementation of a custom-tailored UI screen is requested by a user; displays a window corresponding to the collected window area information on the screen display unit; displays an icon to be displayed in the window on the screen display unit, as setting of the icon to be displayed in the window is requested; displays an icon of an adjusted size on the screen display unit, as setting of a size of the displayed icon is requested; and stores information on the set UI screen in the storage unit.

### Advantageous Effects

According to a method of configuring a user interface (UI) screen of an electronic device terminal and the electronic device terminal for executing the same, a custom-tailored UI screen may be configured by collecting window area information on partitioned areas defined by a user to configure the user interface screen.

### BRIEF DESCRIPTION OF THE DRAWINGS

FIG. 1 is a block diagram showing an electronic device terminal according to an embodiment of the present invention.

FIG. 2 is a flowchart illustrating a method of configuring a user interface screen of an electronic device terminal according to an embodiment of the present invention.

FIGS. 3 to 5 are images illustrating the procedure of setting a size of an icon described in FIG. 2.

FIGS. 6 to 8 are images illustrating examples of custom-tailored UI screens which are set according to the present invention.

FIG. 9 is a flowchart illustrating an example of the step of collecting window area information for implementing a UI screen described in FIG. 2.

FIGS. 10 to 15 are images illustrating the procedure of inputting touch points described in FIG. 9.

FIG. 16 is a flowchart illustrating another example of the step of collecting window area information for implementing a UI screen described in FIG. 2.

FIG. 17 is a flowchart illustrating another example of the step of collecting window area information for implementing a UI screen described in FIG. 2.

FIGS. 18 and 19 are images illustrating the grid-type touch screen described in FIG. 17.

FIG. 20 is a flowchart illustrating another example of the step of collecting window area information for implementing a UI screen described in FIG. 2.

FIGS. 21 and 22 are images illustrating the grid-type touch screen described in FIG. 20.

FIG. 23 is a flowchart illustrating a method of configuring a user interface screen of an electronic device terminal according to another embodiment of the present invention.

FIGS. 24 and 25 are images illustrating the procedure of setting a style of a UI screen described in FIG. 23.

FIGS. 26 to 30 are images illustrating the procedure of setting ‘font/icon color’ described in FIG. 23.

FIG. 31 is a block diagram showing an electronic device terminal according to another embodiment of the present invention.

### DESCRIPTION OF SYMBOLS

100, 200: Electronic device terminal

110: Navigation unit

120: Contents interface unit

130, 230: Storage unit

140, 240: Touch recognition unit

150, 250: Screen display unit

160: Sound output unit

170: IR receive unit

180, 270: Control unit

210: Wireless transmit-receive unit

220: Key input unit

182, 272: Custom-tailored UI setup program

### BEST MODE FOR CARRYING OUT THE INVENTION

The present invention will be hereafter described in further detail, with reference to the accompanying drawings.

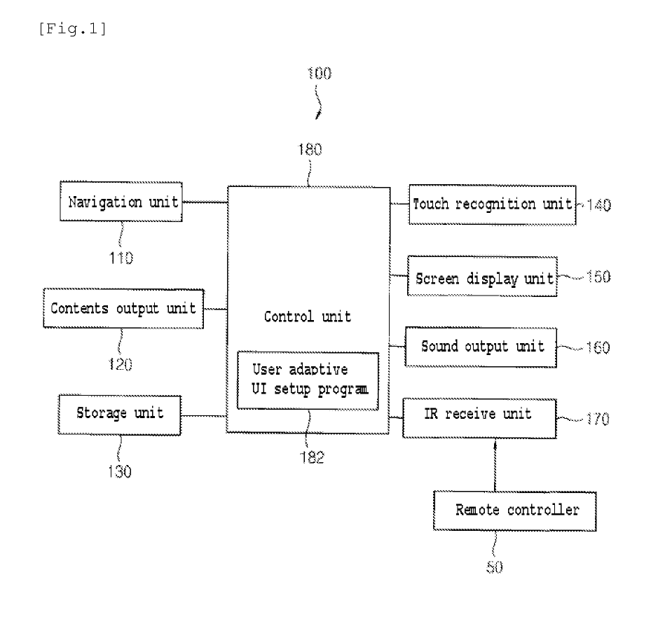

FIG. 1 is a block diagram showing an electronic device 100 terminal according to an embodiment of the present invention.

Referring to FIG. 1, the electronic device terminal 100 terminal according to an embodiment of the present invention includes a navigation unit 110, a contents interface unit 120, a storage unit 130, a touch recognition unit 140, a screen display unit 150, a sound output unit 160, an IR receive unit 170, and a control unit 180. In the embodiment, the electronic device terminal 100 is a navigation terminal of a vehicle.

The navigation unit 110 provides the control unit 180 with audio/video (A/V) signals for navigating the vehicle. The navigation unit 110 may include a position calculation unit (not shown) for calculating information on the current position in association with GPS satellites and a map information storage unit (not shown) for storing map information.

The contents interface unit 120 outputs external A/V signals outputted from a separate contents output device, which is not previously mounted on the vehicle but is mounted on the vehicle by the user after the vehicle is delivered, to the control unit 180. The external A/V signals include satellite wave Digital Multimedia Broadcasting (DMB) signals, terrestrial wave DMB signals, Portable Multimedia Player (PMP) signals, and the like.

The storage unit 130 may be non-volatile memory such as flash memory, Electrically Erasable And Programmable Read Only Memory (EEPROM) or the like, and stores system programs required for basic operations of the electronic device terminal (e.g., an operating system) and/or other application programs.

The touch recognition unit 140 is placed on the front side of the screen display unit 150, and recognizes a process corresponding to user's handling and provides the control unit 180 with recognized touch information. The touch recognition unit 140 may further include a touch panel and a touch driver, and the touch driver recognizes coordinate values corresponding to a touch operation of the user performed on the touch panel and provides the control unit 180 with the coordinate values.

The screen display unit 150 converts the video signals provided by the control unit 180 into images and outputs the images. In the embodiment, the screen display unit 150 may display a variety of screens for implementing a custom-tailored UI screen.

The sound output unit 160 is mounted on the vehicle, converts the audio signals provided by the control unit 180 into sounds and outputs the sounds. In the embodiment, the sound output unit 160 may output voice messages for implementing a custom-tailored UI screen.

The IR receive unit 170 receives remote control signals, e.g., IR signals, provided by an external remote controller 50 and provides the control unit 180 with the remote control signals.

The control unit 180 controls the electronic device terminal 100 to perform the functions of a navigation terminal of a vehicle by providing the screen display unit 150 or the sound output unit 160 with navigation information of the vehicle provided by the navigation unit 110.

The control unit 180 includes a custom-tailored UI setup program 182, collects window area information based on touch operations corresponding to user's handling, and implements a custom-tailored UI screen. The window area information may be collected using cross points (i.e., nodes) between links on a grid-type touch screen, may be collected using the links, or may be collected using sub-areas defined by the links.

According to one example, the window area information may be collected by touching a plurality of touch points by the user on the grid-type touch screen where the cross points between the links are set as the touch points. According to another example, the window area information may be defined and collected by one or more touched sub-areas when the user touches the sub-areas on the grid-type touch screen. According to still another example, the window area information may be defined and collected by an area which connects touched links when the user touches the links on the grid-type touch screen.

The custom-tailored UI setup program 182 will be described in further detail with reference to the flowcharts and images described below.

The electronic device terminal 100 according to the present invention may further include a remote controller 50. The remote controller 50 wirelessly transmits remote control signals corresponding to user's handling to the IR receive unit 170.

The user may request the IR receive unit 170 of the electronic device terminal 100 to independently display a vehicle TV screen on the screen display unit 150 or request the electronic device terminal 100 to display a vehicle navigation map image outputted from the navigation unit 110, using the remote controller 50. In addition, the user may request the IR receive unit 170 of the electronic device terminal 100 to display a variety of DMB images or PMP images outputted from the contents interface unit 120 using the remote controller 50. In addition, the user may request the IR receive unit 170 of the electronic device terminal 100 to process and display the vehicle navigation map image and a variety of the DMB or PMP images in a Picture-In-Picture (PIP) manner using the remote controller 50. In addition, the user may request the IR receive unit 170 of the electronic device terminal 100 to process and display the vehicle navigation map image and a variety of the DMB or PMP images in a Picture-On-Picture (POP) manner using the remote controller 50.

Therefore, the user may be further properly provided with navigation A/V signals, DMB A/V signals, and PMP A/V signals, as well as vehicle TV signals, through the screen display unit 150 while driving.

Although it is shown that the custom-tailored UI setup program 182 is stored in the control unit 180 in the embodiment, the custom-tailored UI setup program 182 may be stored in the storage unit 130 and transferred to the control unit 180 in response to a request of the control unit 180.

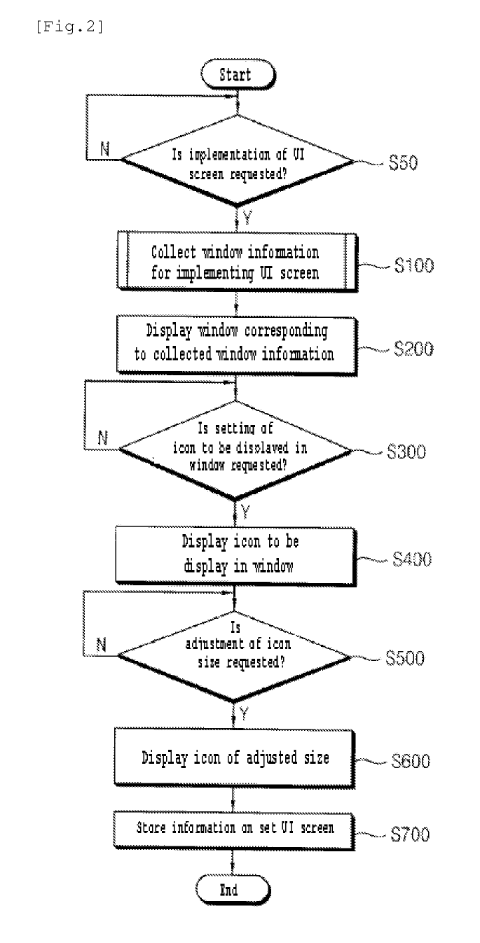

FIG. 2 is a flowchart illustrating a method of configuring a user interface screen of an electronic device terminal according to an embodiment of the present invention.

Referring to FIGS. 1 and 2, the custom-tailored UI setup program 182 examines whether or not the user requests implementation of a custom-tailored UI screen S50. The request of implementing a custom-tailored UI screen may be recognized in a variety of forms. For example, a menu is displayed on the initial screen of the electronic device terminal, and the request may be recognized if the user touches a menu item for implementing the custom-tailored UI screen among the provided menu items.

If it is determined that the user requests implementation of a custom-tailored UI screen in step S50, the custom-tailored UI setup program 182 collects window area information for implementing a UI screen S100. In the embodiment, the window area information may be collected based on touch operations corresponding to user's handling.

The window area information may be defined by an area connecting touched touch points, as the user touches a plurality of touch points on the grid-type touch screen where cross points (i.e., nodes) between links are set as touch points. For example, the window area information may be defined by an area connecting four touch points, as the four touch points are touched.

In addition, the window area information may be defined by one or more touched sub-areas, as the user touches the sub-areas on the grid-type touch screen. For example, the window area information may be defined by an area corresponding to the sub-areas, as at least one sub-area is touched.

In addition, the window area information may be defined by an area connecting touched links, as the user touches the links on the grid-type touch screen. According to an example, the window area information may be defined by an area which is defined by connecting touched links with one another, as four or more links are touched. According to another example, the window area information may be defined if at least one link is touched. That is, although the leftmost link, the uppermost link and the lowermost link of the screen are untouched, an area on the left side of the screen including touched links may be collected as the window area information by touching only one or more links arranged in the vertical direction of the screen.

Subsequently, the custom-tailored UI setup program 182 displays a window corresponding to the collected window area information S200. The window may be displayed in a highlighted type in which the window is displayed in a form brighter than the other windows, or the window may be displayed in a line type in which outer lines defining an area are displayed in a bright form.

Subsequently, the custom-tailored UI setup program 182 examines whether or not the user requests setting of an icon that will be displayed in the window S300. The icon may be selected from a plurality of icons arranged and displayed in a line in the top portion of the screen display unit.

As the user requests to set an icon that will be displayed in the window in step S300, the custom-tailored UI setup program 182 displays the icon that will be displayed in the window S400. That is, as the user touches one of the icons displayed in the top portion of the screen, the touch recognition unit 140 recognizes the icon. As the icon is recognized, the custom-tailored UI setup program 182 displays the icon on the window defined by the user.

Subsequently, the custom-tailored UI setup program 182 examines whether or not the user requests adjustment of the size of the icon S500. As the user requests to adjust the size of the icon in step S500, the custom-tailored UI setup program 182 displays an icon of a size selected in response to user's handling S600.

FIGS. 3 to 5 are images illustrating the procedure of setting a size of an icon described in FIG. 2.

Referring to FIG. 3, when an icon is displayed in an area partitioned by user's selection, a − symbol requesting reduction in the size of the icon is displayed on one side of the lower portion, and a + symbol requesting enlargement in the size of the icon is displayed on the other side of the lower portion.

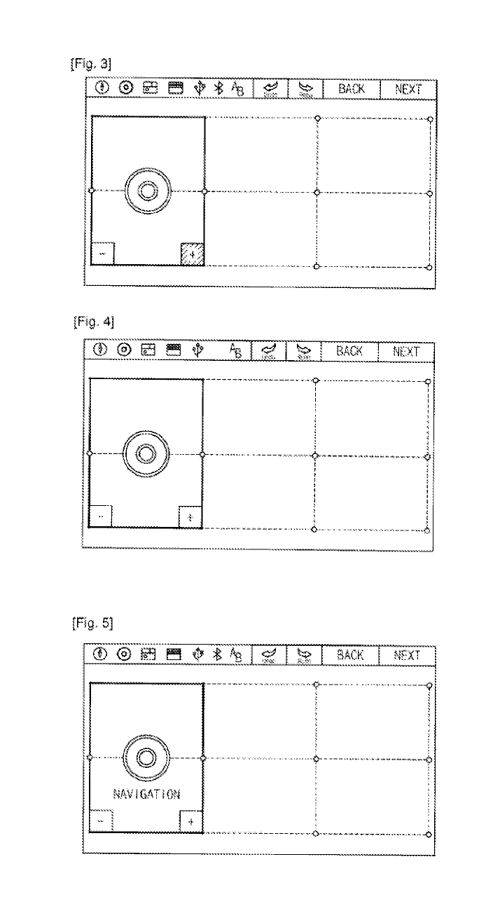

Referring to FIG. 4, as the user clicks the + symbol, the size of the icon displayed in the partitioned area is enlarged.

Referring to FIG. 5, after the size of the icon is set, a text describing the icon, e.g., a text such as NAVIGATION, may be further displayed below a corresponding icon.

Returning to describing FIG. 2, the custom-tailored UI setup program 182 stores information on the custom-tailored UI screen set as described above in the storage unit 130 S700. That is, while the selected icon is displayed in the window partitioned by the user, the custom-tailored UI setup program 182 stores the information on the custom-tailored UI screen, in which the size of a corresponding icon is adjusted, in the storage unit 130.

FIGS. 6 to 8 are images illustrating examples of custom-tailored UI screens which are set according to the present invention.

Referring to FIG. 6, six areas partitioned in a uniform size are displayed in the form of 2 by 3 in the custom-tailored UI screen. In each of the areas, an icon for selecting NAVIGATION, an icon for selecting MUSIC, an icon for selecting TUNER, an icon for selecting DVD, an icon for selecting USB, or an icon for selecting BLUETOOTH is displayed. The custom-tailored UI screen shown in FIG. 6 may be edited by a user who selects NAVIGATION, MUSIC, TUNER, DVD, USB, or BLUETOOTH.

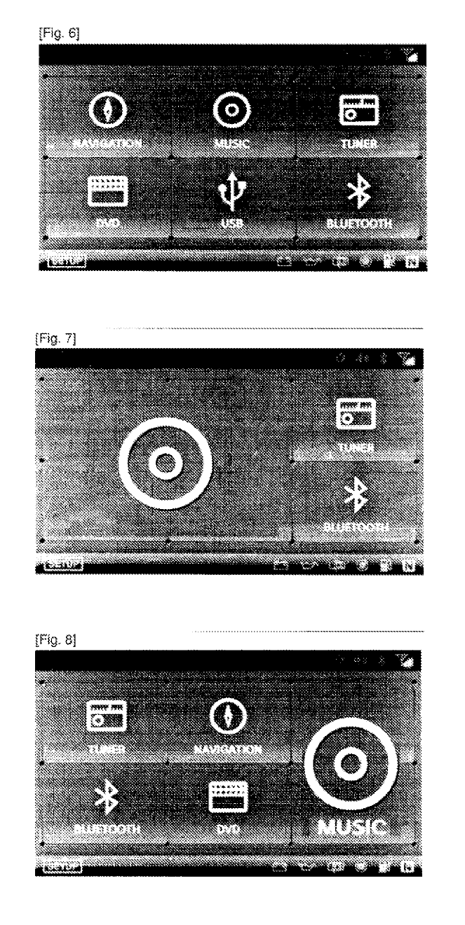

Referring to FIG. 7, one large area is displayed on the left side of the custom-tailored UI screen, and two small areas are displayed on the right side of the custom-tailored UI screen. An icon for selecting MUSIC is displayed in the large area, and an icon for selecting TUNER and an icon for selecting BLUETOOTH are respectively displayed in the small areas. The custom-tailored UI screen shown in FIG. 7 may be edited by a user who mainly selects MUSIC and occasionally selects TUNER or BLUE TOOTH.

Referring to FIG. 8, four small areas are displayed on the left side of the custom-tailored UI screen, and one large area is displayed on the right side of the custom-tailored UI screen. An icon for selecting TUNER, an icon for selecting NAVIGATION, an icon for selecting BLUETOOTH, and an icon for selecting DVD are respectively displayed in the four small areas, and an icon for selecting MUSIC is displayed in the large area. The custom-tailored UI screen shown in FIG. 8 may be edited by a user who mainly selects MUSIC and occasionally selects TUNER, NAVIGATION, BLUETOOTH or DVD.

As described above, according to the present invention, a user may set arrangement of mainly used icons on the custom-tailored UI screen, and the size of an icon may also be set to a type desired by the user.

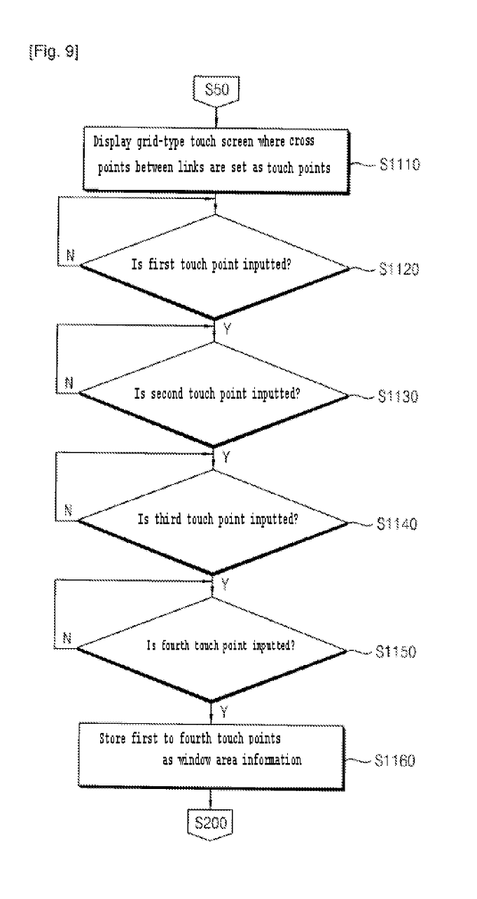

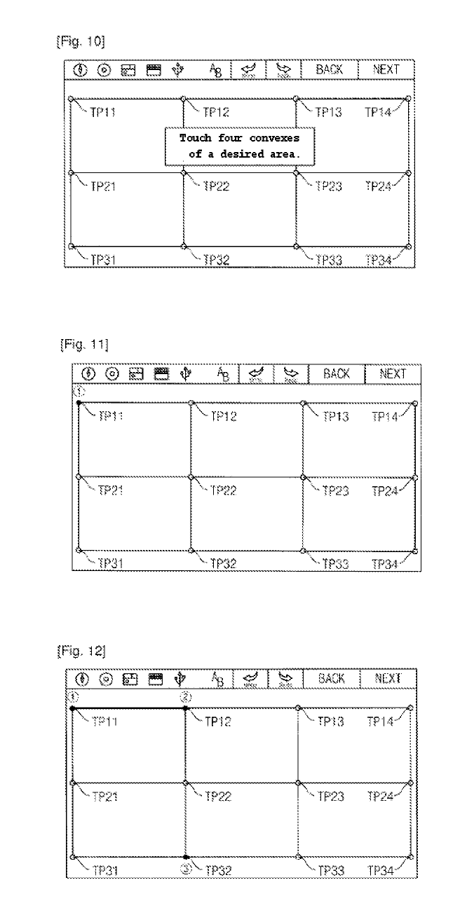

FIG. 9 is a flowchart illustrating an example of the step of collecting window area information for implementing a UI screen described in FIG. 2. FIGS. 10 to 15 are images illustrating the procedure of inputting touch points described in FIG. 9.

Referring to FIGS. 9 to 15, the custom-tailored UI setup program 182 displays a grid-type touch screen where each of cross points between links is set as a touch point S1110. For example, as shown in FIG. 10, a plurality of touch points TP11, TP12, TP13 and TP14 is arranged in the first row, a plurality of touch points TP21, TP22, TP23 and TP24 is arranged in the second row, and a plurality of touch points TP31, TP32, TP33 and TP34 is arranged in the third row. In addition, a separate message saying that ‘Touch four vertexes of a desired area’ may be displayed.

Subsequently, the custom-tailored UI setup program 182 examines whether or not information on a first touch point is inputted by checking whether or not the first touch point is touched S1120. For example, as shown in FIG. 11, a touch point corresponding to TP11 may be inputted as information on the first touch point.

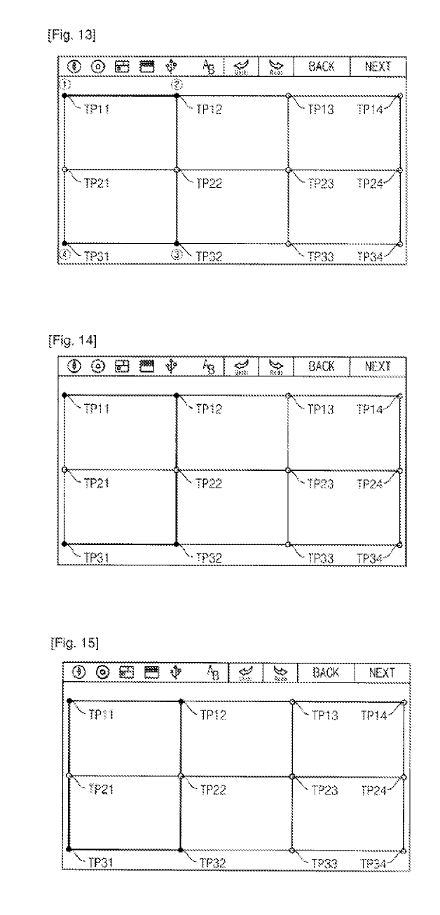

Subsequently, the custom-tailored UI setup program 182 examines whether or not information on a second touch point is inputted by checking whether or not the second touch point is touched S1130. For example, as shown in FIG. 12, a touch point corresponding to TP12 may be inputted as information on the second touch point.

Subsequently, the custom-tailored UI setup program 182 examines whether or not information on a third touch point is inputted by checking whether or not the third touch point is touched S1140. For example, as shown in FIG. 13, a touch point corresponding to TP32 may be inputted as information on the third touch point.

Subsequently, the custom-tailored UI setup program 182 examines whether or not information on a fourth touch point is inputted by checking whether or not the fourth touch point is touched S1150. For example, as shown in FIG. 14, a touch point corresponding to TP31 may be inputted as information on the fourth touch point.

Subsequently, the custom-tailored UI setup program 182 stores the first to fourth touch points as window area information S1160 and feeds back returns) to step S200. That is, as shown in FIG. 14, an area defined by TP11, TP12, TP32 and TP31 is stored as window area information. Subsequently, as shown in FIG. 15, as a variety of icons arranged in the upper portion of the screen are selected by user's touch (step S200 of FIG. 2), corresponding icons are displayed in a corresponding window area S400.

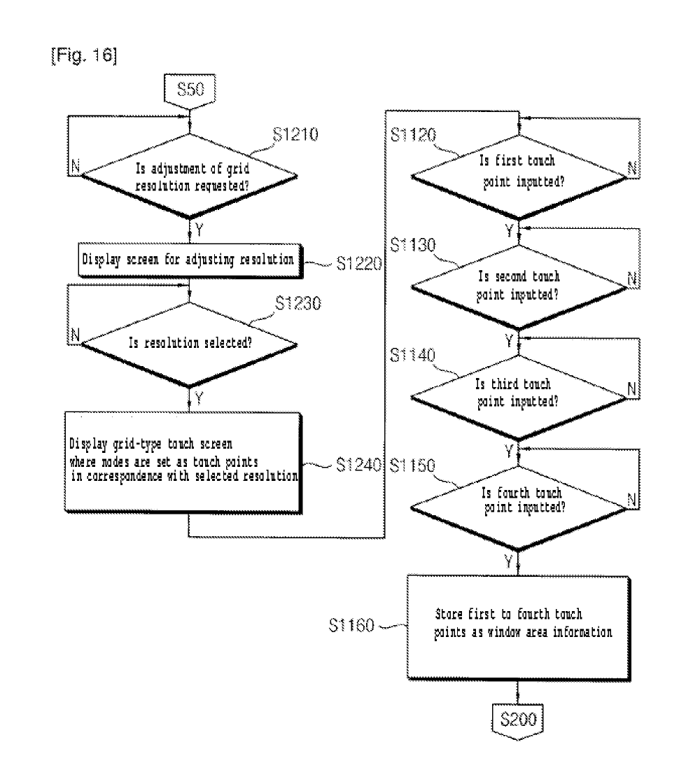

FIG. 16 is a flowchart illustrating another example of the step of collecting window area information for implementing a UI screen described in FIG. 2.

Referring to FIG. 16, the custom-tailored UI setup program 182 examines whether or not the user requests adjustment of grid resolution S1210.

As the user requests adjustment of grid resolution in step S1210, the custom-tailored UI setup program 182 displays a screen for adjusting resolution S1220. The screen for adjusting resolution may be displayed in the form of a separate popup window and may receive information on X-axis and Y-axis resolutions for user's selection. Here, the displayed X-axis and Y-axis resolutions may be provided in the form of a provided numeral. For example, 1, 2, 3, 4, 5, 6, or 7 may be provided as the X-axis resolution, and 1, 2, 3, 4, 5, 6, or 7 may be provided as the Y-axis resolution. Accordingly, if the user selects, for example, 6 as X-axis resolution and 5 as Y-axis resolution, resolution of the displayed grid is 5 by 6.

Subsequently, the custom-tailored UI setup program 182 examines whether or not the user selects a resolution S1230. Subsequently, the custom-tailored UI setup program 182 displays a grid-type touch screen where nodes are set as touch points in correspondence with the selected resolution S1240.

Subsequently, the custom-tailored UI setup program 182 examines whether or not information on a first touch point is inputted by checking whether or not the first touch point is touched S1120. For example, as shown in FIG. 11, a touch point corresponding to TP11 may be inputted as information on the first touch point.

Subsequently, the custom-tailored UI setup program 182 examines whether or not information on a second touch point is inputted by checking whether or not the second touch point is touched S1130. For example, as shown in FIG. 12, a touch point corresponding to TP12 may be inputted as information on the second touch point.

Subsequently, the custom-tailored UI setup program 182 examines whether or not information on a third touch point is inputted by checking whether or not the third touch point is touched S1140. For example, as shown in FIG. 13, a touch point corresponding to TP32 may be inputted as information on the third touch point.

Subsequently, the custom-tailored UI setup program 182 examines whether or not information on a fourth touch point is inputted by checking whether or not the fourth touch point is touched S1150. For example, as shown in FIG. 14, a touch point corresponding to TP31 may be inputted as information on the fourth touch point.

Subsequently, the custom-tailored UI setup program 182 stores the first to fourth touch points as window area information S1160 and feeds back (→ returns) to step S200. That is, as shown in FIG. 14, an area defined by TP11, TP12, TP32 and TP31 is stored as window area information. Subsequently, as shown in FIG. 15, as a variety of icons arranged in the upper portion of the screen are selected by user's touch (step S200 of FIG. 2), corresponding icons are displayed in a corresponding window area S400.

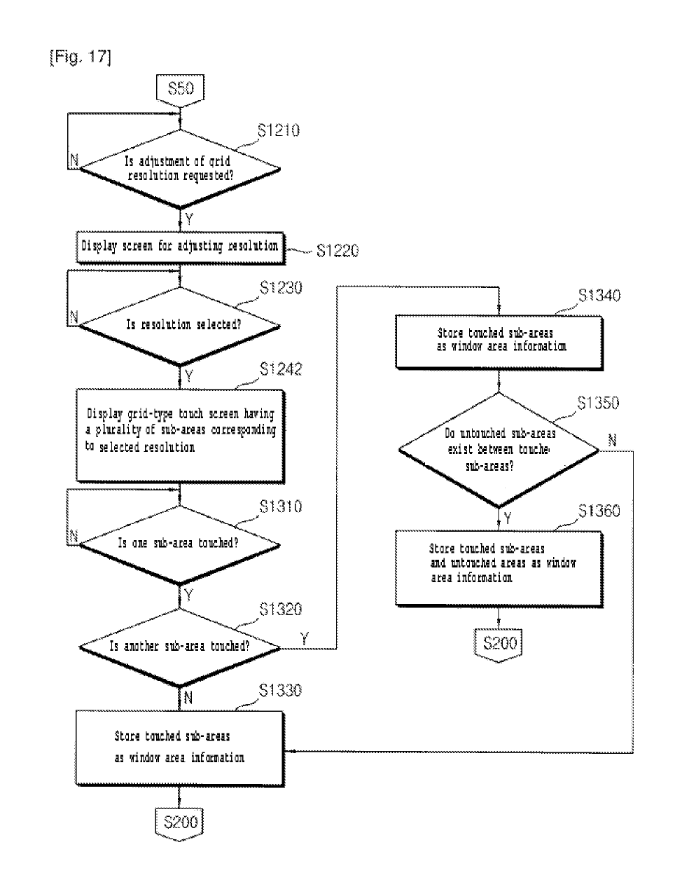

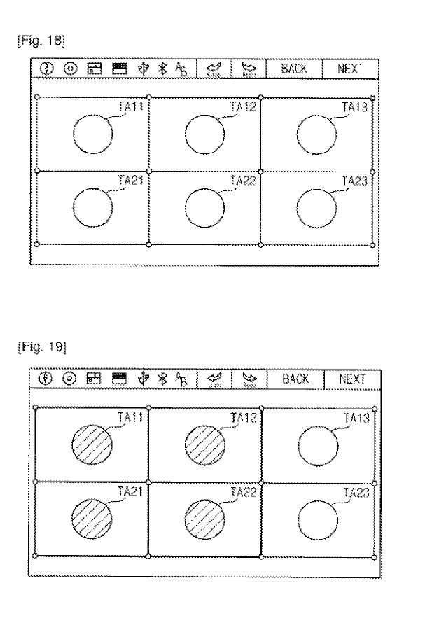

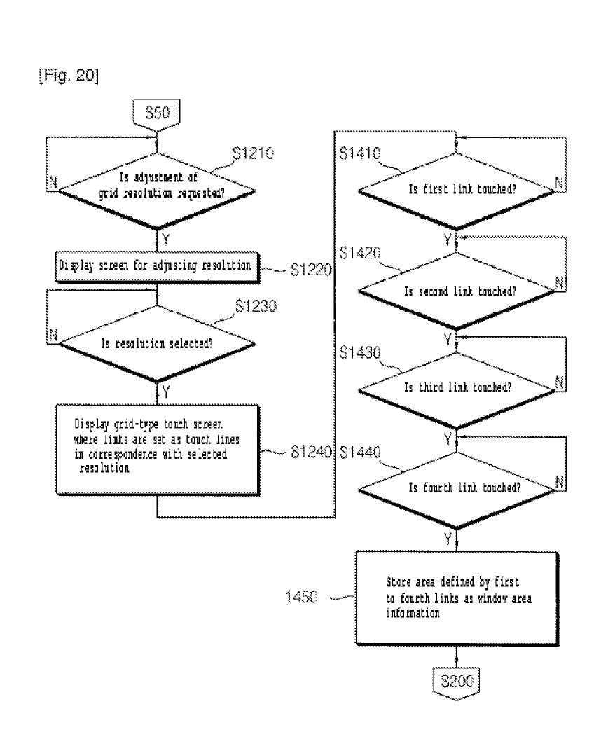

FIG. 17 is a flowchart illustrating another example of the step of collecting window area information for implementing a UI screen described in FIG. 2. FIGS. 18 and 19 are images illustrating the grid-type touch screen described in FIG. 17.

Referring to FIGS. 17 and 19, the custom-tailored UI setup program 182 examines whether or not the user requests adjustment of grid resolution S1210.

As the user requests adjustment of grid resolution in step S1210, the custom-tailored UI setup program 182 displays a screen for adjusting resolution S1220.

Subsequently, the custom-tailored UI setup program 182 examines whether or not the user selects a resolution S1230.

Subsequently, the custom-tailored UI setup program 182 displays a grid-type touch screen having a plurality of sub-areas corresponding to the resolution selected by the user S1242. For example, as shown in FIG. 18, a first sub-area TA11, a second sub-area TA12 and a third sub-area TA13 may be arranged in the first row of the grid-type touch screen, and a fourth sub-area TA21, a fifth sub-area TA22, and a sixth sub-area TA33 may be arranged in the second row. Subsequently, the custom-tailored UI setup program 182 examines whether or not the user touches one of the sub-areas on the grid-type touch screen displayed in step S1242 S1310.

If it is determined that a sub-area is touched in step S1310, the custom-tailored UI setup program 182 examines whether or not the user touches another sub-area S1320. If it is determined that the user does not touch another sub-area in step S1320, the custom-tailored UI setup program 182 stores the touched sub-area as window area information S1330 and feeds back returns) to step S200.

If it is determined that the user touches another sub-area in step S1320, the custom-tailored UI setup program 182 stores the touched sub-areas as window area information S1340. For example, as shown in FIG. 19, if user touches the first, the second, the fourth and the fifth sub-areas TA11, TA12, TA21 and TA22, the touched sub-areas TA11, TA12, TA21 and TA22 are stored as window area information.

Subsequently, the custom-tailored UI setup program 182 examines whether or not untouched sub-areas exist between the touched sub-areas S1350. For example, if the user selects a grid-type touch screen having a plurality of sub-areas corresponding to a high resolution, it is difficult for the user to select desired sub-areas one by one. Accordingly, according to step S1350, although the user does not touch adjacent sub-areas one by one, the user may select a window area only by selecting outer sub-areas which can define the area.

If it is determined that untouched sub-areas do not exist in step S1350, the custom-tailored UI setup program 182 feeds back returns) to step S1330.

If it is determined that untouched sub-areas exist in step S1350, the custom-tailored UI setup program 182 stores the touched sub-areas and the untouched sub-areas as window area information S1360 and feeds back returns) to step S200.

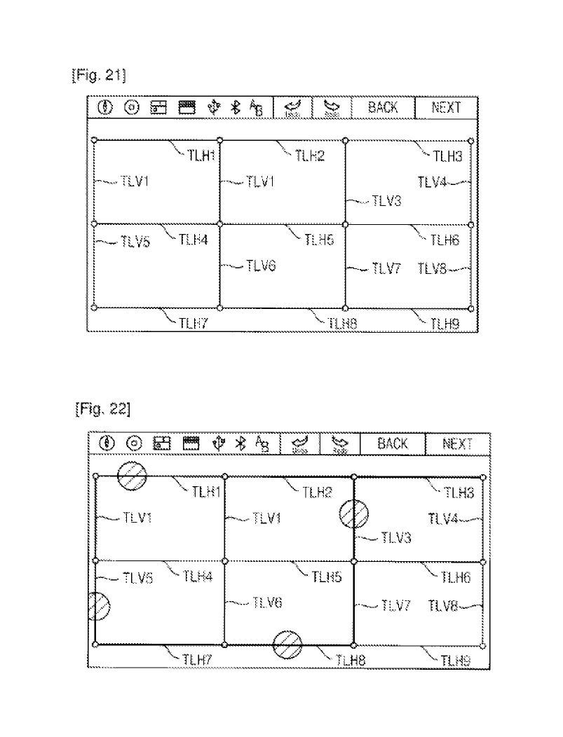

FIG. 20 is a flowchart illustrating another example of the step of collecting window area information for implementing a UI screen described in FIG. 2. FIGS. 21 and 22 are images illustrating the grid-type touch screen described in FIG. 20.

Referring to FIGS. 20 and 22, the custom-tailored UI setup program 182 examines whether or not the user requests adjustment of grid resolution S1210.

As the user requests adjustment of grid resolution in step S1210, the custom-tailored UI setup program 182 displays a screen for adjusting resolution S1220.

Subsequently, the custom-tailored UI setup program 182 examines whether or not the user selects a resolution S1230.

Subsequently, the custom-tailored UI setup program 182 displays a grid-type touch screen where links are set as touch lines in correspondence with the selected resolution S1244. For example, as shown in FIG. 21, a plurality of horizontal links TLH1, TLH2 and TLH3 is arranged in the first row of the grid-type touch screen. A plurality of horizontal links TLH4, TLH5 and TLH6 is arranged in the second row, and a plurality of horizontal links TLH7, TLH8 and TLH9 is arranged in the third row. In addition, a plurality of vertical links TLV1 and TLV2 is arranged in the first column, a plurality of vertical links TLV3 and TLV4 is arranged in the second column, a plurality of vertical links TLV5 and TLV6 is arranged in the third column, and a plurality of vertical links TLV7 and TLV8 is arranged in the fourth column.

Subsequently, the custom-tailored UI setup program 182 examines whether or not a first link is touched S1410. For example, a link named as TLH1 is touched in FIG. 21. Accordingly, links named as TLH1, TLH2 and TLH3 become active.

Subsequently, after the first link is touched in step S1410, the custom-tailored UI setup program 182 examines whether or not a second link is touched S1420. For example, a link named as TLV5 is touched in FIG. 21. Accordingly, links named as TLV5 and TLV6 become active.

Subsequently, after the second link is touched in step S1420, the custom-tailored UI setup program 182 examines whether or not a third link is touched S1430. For example, a link named as TLH8 is touched in FIG. 21. Accordingly, links named as TLH7, TLH8 and TLH9 become active.

Subsequently, after the third link is touched in step S1430, the custom-tailored UI setup program 182 examines whether or not a fourth link is touched S1440. For example, a link named as TLV2 is touched in FIG. 21. Accordingly, links named as TLV2 and TLV1 become active.

Subsequently, after the fourth link is touched in step S1440, the custom-tailored UI setup program 182 stores an area defined by the first to fourth links as window area information S1450 and feeds back returns) to step S200. As shown in FIG. 22, the area defined by the links named as TLH1, TLH2, TLV5, TLV6, TLH8, TLH7, TLV2 and TLV1 is stored as window area information.

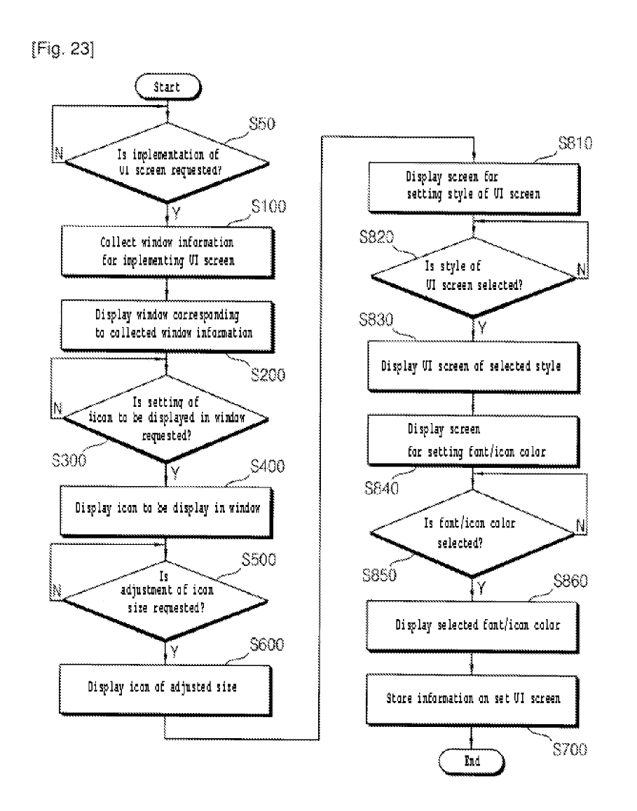

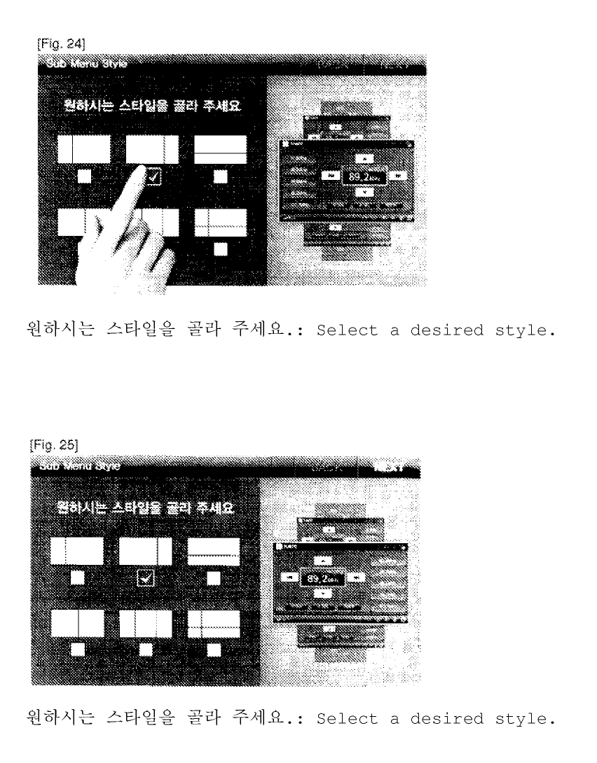

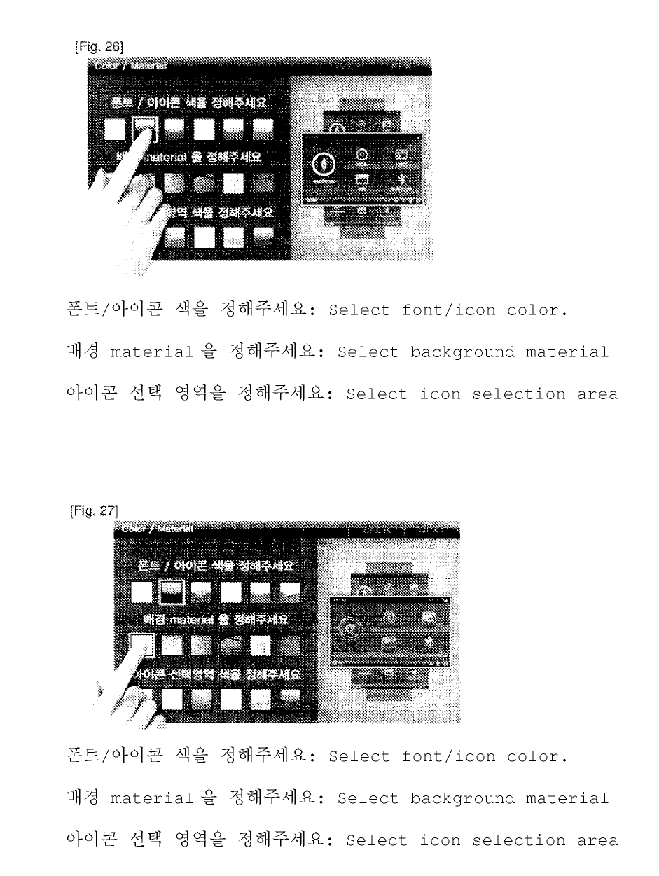

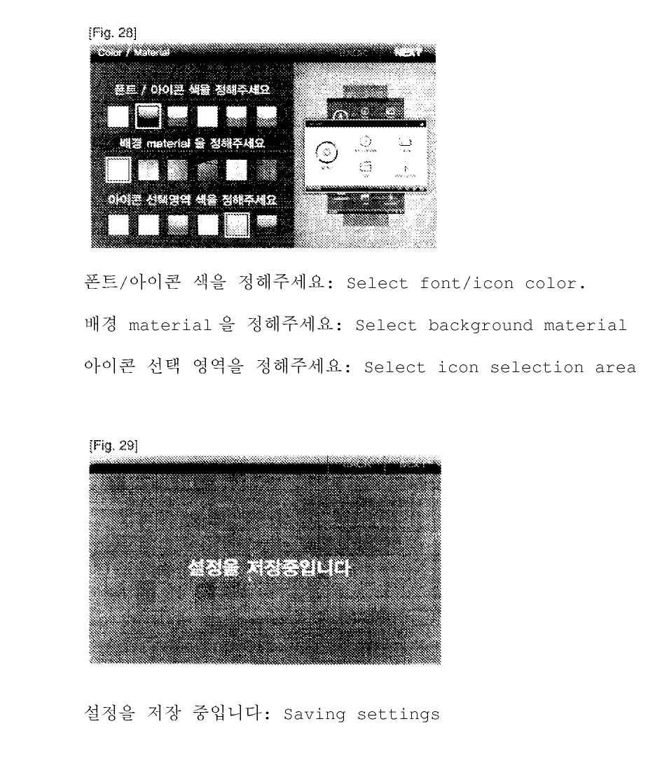

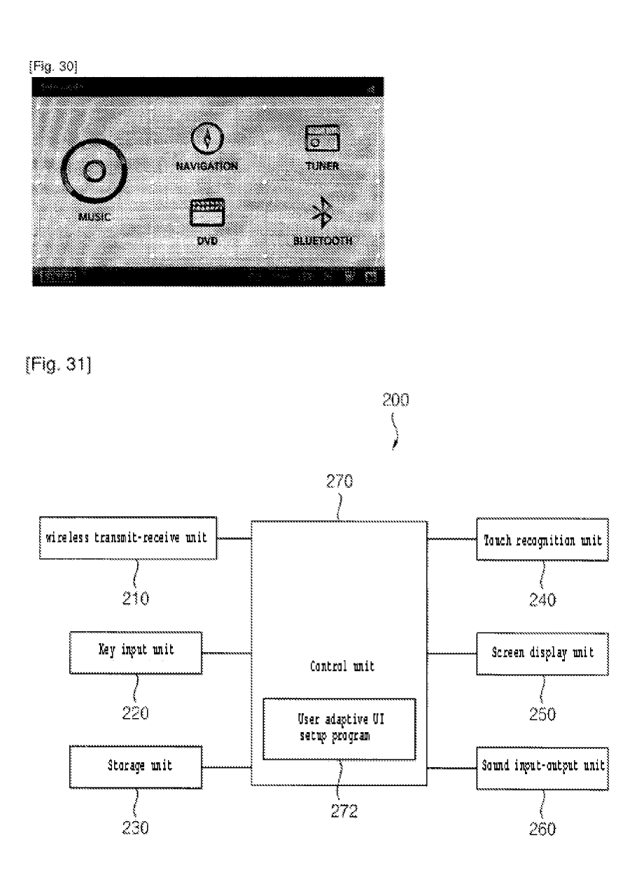

FIG. 23 is a flowchart illustrating a method of configuring a user interface screen of an electronic device terminal according to another embodiment of the present invention. FIGS. 24 and 25 are images illustrating the procedure of setting a style of a UI screen described in FIG. 23. FIGS. 26 to 30 are images illustrating the procedure of setting ‘font/icon color’ described in FIG. 23.

Referring to FIGS. 1 and 23 to 30, the custom-tailored UI setup program 182 examines whether or not the user requests implementation of a UI screen S50.

If the user requests implementation of a UI screen in steps S50, the custom-tailored UI setup program 182 collects window area information for implementing a UI screen through the touch recognition unit 140 S100. Since collection of the window area information is described in detail with reference to FIGS. 9 to 22, detailed descriptions thereof will be omitted.

Subsequently, the custom-tailored UI setup program 182 displays a window corresponding to the collected window area information S200.

Subsequently, the custom-tailored UI setup program 182 examines whether or not the user requests setting of an icon that will be displayed in the window S300.

As the user requests to set an icon that will be displayed in the window in step S300, the custom-tailored UI setup program 182 displays the icon that will be displayed in the window on the screen display unit 150 S400.

Subsequently, the custom-tailored UI setup program 182 examines whether or not the user requests adjustment of the size of the icon S500. For example, as shown in FIG. 6, when the icon is displayed in a window area set by the user, a − symbol requesting reduction in the size of the icon is displayed on one side of the lower portion, and a +symbol requesting enlargement in the size of the icon is displayed on the other side of the lower portion.

Subsequently, the custom-tailored UI setup program 182 displays the icon of an adjusted size on the screen display unit 150 S600. For example, as the user selects the displayed − or + symbol, the icon displayed in the window area is reduced or enlarged. For example, as the user selects the displayed +symbol, an enlarged icon is displayed as shown in FIG. 7. Additionally, a text describing the icon may be further displayed below the displayed icon as shown in FIG. 8.

Subsequently, the custom-tailored UI setup program 182 displays a UI screen style setup screen on the screen display unit 150 S810. For example, as shown in FIG. 24, a window for selecting a desired style is displayed on the left side of the screen, and the currently set UI screen style is displayed on the right side of the screen. For example, as a UI screen style of the user, radio channels for user's selection may be displayed in the left area of the screen, and buttons for channel up and down, buttons for selecting a leftmost or a rightmost channel, information channel displaying a currently set radio channel, and the like may be included in the right area of the screen.

Subsequently, the custom-tailored UI setup program 182 examines whether or not the user selects a style of the UI screen S820.

Subsequently, the custom-tailored UI setup program 182 displays a UI screen style selected by the user on the screen display unit 150 S830. For example, as shown in FIG. 24, if a UI screen style arranging a main screen on the left side and a sub-screen on the right side is requested to be changed to a UI screen style arranging the main screen on the right side and the sub-screen on the left side, a UI screen style as shown in FIG. 25 is displayed.

Subsequently, the custom-tailored UI setup program 182 displays a screen for setting ‘font/icon color’ S840. For example, as shown in FIG. 26, after the user selects a UI screen style, a screen for setting ‘font/icon color’ of a corresponding UI screen is displayed. The ‘font/icon color’ may be white, black, blue, amber, red, or green.

Subsequently, the custom-tailored UI setup program 182 examines whether or not the user selects the ‘font/icon color’ S850.

Subsequently, the custom-tailored UI setup program 182 displays the ‘font/icon color’ selected by the user on the screen display unit 150 S860.

Subsequently, the custom-tailored UI setup program 182 stores information on the set UI screen in the storage unit 130 S700.

A navigation terminal is described above as an example of an electronic device terminal where a custom-tailored UI screen is implemented. However, the present invention may be applied to other electronic device terminals having a UI screen. Hereinafter, an example of implementing a custom-tailored UI screen according to the present invention in a mobile communication terminal such as a cellular phone will be described.

FIG. 31 is a block diagram showing an electronic device terminal 200 according to another embodiment of the present invention.

Referring to FIG. 31, an electronic device terminal 200 according to another embodiment of the present invention includes a wireless transmit-receive unit 210, a key input unit 220, a storage unit 230, a touch recognition unit 240, a screen display unit 250, a sound input-output unit 260, and a control unit 270. In the embodiment, the electronic device terminal 200 is a mobile communication terminal such as a cellular phone.

The wireless transmit-receive unit 210 receives radio frequency (RF) signals induced by an antenna (not shown), converts the radio frequency signals into intermediate frequency signals, converts the intermediate frequency signals into base band signals, and provides the control unit 270 with the base band signals, and the wireless transmit-receive unit 210 converts base band signals provided by the control unit 270 into intermediate frequency signals, converts the intermediate frequency signals into radio frequency signals, and provides the antenna with the radio frequency signals.

Alternatively, the wireless transmit-receive unit 210 may use a direct conversion method which directly demodulates received radio frequency signals without performing frequency conversion, instead of using a heterodyne reception method which converts radio frequency signals into intermediate frequency signals and demodulates the intermediate frequency signals into base band signals.

The key input unit 220 includes a plurality of keys for inputting numerals or characters and function keys for performing special functions. If a user handles a key, a key input signal corresponding to the key handling is provided to the control unit 270. Particularly, the key input unit 220 receives a key input for changing attributes of each partitioned area through a certain setup window by the user and a key input indicating a certain focus event, and provides the control unit 270 with an event signal corresponding to the key input.

The storage unit 230 may be non-volatile memory such as flash memory, Electrically Erasable And Programmable Read Only Memory (EEPROM) or the like, and stores system programs required for basic operations of the electronic device terminal (e.g., an operating system) and/or other application programs.

The touch recognition unit 240 is placed on the front side of the screen display unit 250, and recognizes a process corresponding to user's handling and provides the control unit 270 with recognized touch information.

The screen display unit 250 converts the video signals provided by the control unit 270 into images and outputs the images. The sound input-output unit 260 outputs voices of the user and voices of a voice communication counterpart in a voice communication. In addition, in the voice communication, the sound input-output unit 260 receives voices of the user, converts the inputted voices into corresponding electrical signals, and provides the control unit 270 with the electrical signals.

The control unit 270 performs controls and processes for performing the functions unique to the electronic device terminal and voice communications. To this end, the control unit 270 may include a base band processor for processing base band signals provided by the wireless transmit-receive unit 210 or a vocoder (not shown) for processing transmitted and received voices in digital.

In addition, the control unit 270 includes a custom-tailored UI setup program 272, and collects window area information based on touch operations corresponding to user's handling and implements a custom-tailored UI screen. The custom-tailored UI setup program 272 performs operations the same as those of the custom-tailored UI setup program 182 set in FIGS. 1 to 30. Therefore, detailed descriptions thereof will be omitted.

Although a navigation terminal and a mobile communication terminal are described above as examples of the electronic device terminal, the electronic device terminal of the present invention is not limited only to the mobile communication terminal, and the electronic device terminal may include a variety of electronic device terminals such as a personal digital assistant, a portable multimedia player, an MP3 player, and the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, according to the present invention, a custom-tailored user interface (UI) screen may be configured by collecting window area information on partition areas defined by a user to configure the UI screen of an electronic device terminal such as a navigation terminal or a mobile communication terminal. That is, only the icons corresponding to specific functions selected among a variety of functions provided in the electronic device can be implemented on the UI screen to the taste of the user. Therefore, a custom-tailored UI screen can be implemented instead of standardized UI screens, and thus usability of the user for the electronic device can be enhanced.

1. A method of configuring a user interface screen of an electronic device terminal, the method comprising the steps of:
collecting window area information for implementing the user interface (UI) screen in response to a touch of a user, as implementation of a custom-tailored UI screen is requested;
displaying a window corresponding to the collected window area information;
displaying an icon to be displayed in the window, as setting of the icon to be displayed in the window is requested;
displaying an icon of an adjusted size, as setting of a size of the displayed icon is requested; and
storing information on the set UI screen.

2. The method according to claim 1, wherein the window area information is an area defined based on touched cross points, as the cross points between links are touched by a user on a grid-type touch screen where the cross points between the links are set as touch points.

3. The method according to claim 1, wherein the step of collecting window area information for implementing the UI screen includes the steps of:
displaying a grid-type touch screen where cross points between links are set as touch points; and
storing a first touch point, a second touch point, a third touch point, and a fourth touch point as the window area information, as the first to fourth touch points are inputted.

4. The method according to claim 1, wherein the step of collecting window area information for implementing the UI screen includes the steps of:
displaying a screen for adjusting resolution, as adjustment of grid resolution is requested;
displaying a grid-type touch screen where nodes are set as touch points in correspondence with a selected resolution, as the resolution is selected;
displaying the grid-type touch screen where cross points between links are set as the touch points; and
storing a first touch point, a second touch point, a third touch point, and a fourth touch point as the window area information, as the first to fourth touch points are inputted.

5. The method according to claim 1, wherein the window area information is an area defined by touched sub-areas, as the sub-areas are touched by a user on a grid-type touch screen where sub-areas partitioned by links are set as touch points.

6. The method according to claim 1, wherein the step of collecting window area information for implementing the UI screen includes the steps of:
displaying a screen for adjusting resolution, as adjustment of grid resolution is requested;
displaying a grid-type touch screen having a plurality of sub-areas corresponding to a selected resolution, as the resolution is selected;
examining whether or not another sub-area is touched, as one of the sub-areas is touched;
storing touched sub-areas, if it is determined that another sub-area is touched;
examining whether or not untouched sub-areas exist between the touched sub-areas;
storing the touched sub-areas and the untouched sub-areas as the window area information, if it is determined that the untouched sub-areas exist between the touched sub-areas; and
storing the touched sub-areas as the window area information, if it is determined that the untouched sub-areas do not exist between the touched sub-areas or another sub-area is not touched.

7. The method according to claim 1, wherein the window area information is an area defined by touched links, as the links are touched by a user on a grid-type touch screen where the links are set as touch points.

8. The method according to claim 1, wherein the step of collecting window area information for implementing the UI screen includes the steps of:
displaying a screen for adjusting resolution, as adjustment of grid resolution is requested;
displaying a grid-type touch screen where links are set as touch lines in correspondence with a selected resolution, as the resolution is selected; and
storing an area defined by a first link, a second link, a third link, and a fourth link as the window area information, as the first to fourth links are touched on the displayed grid-type touch screen.

9. An electronic device terminal comprising:
a touch recognition unit;
a screen display unit;
a storage unit; and
a control unit for collecting window area information for implementing a user interface (UI) screen inputted through the touch recognition unit, as implementation of a custom-tailored UI screen is requested by a user; displaying a window corresponding to the collected window area information on the screen display unit; displaying an icon to be displayed in the window on the screen display unit, as setting of the icon to be displayed in the window is requested; displaying an icon of an adjusted size on the screen display unit, as setting of a size of the displayed icon is requested; and storing information on the set UI screen in the storage unit.

10. The terminal according to claim 9, wherein the control unit displays a grid-type touch screen on the screen display unit in order to collect the window area information, and the window area information is an area defined based on touched cross points, as the cross points between links are touched by the user.

11. The terminal according to claim 9, wherein the control unit displays a grid-type touch screen on the screen display unit in order to collect the window area information, and the window area information is an area defined by touched sub-areas, as the sub-areas defined by links are touched by the user.

12. The terminal according to claim 9, wherein the control unit displays a grid-type touch screen on the screen display unit in order to collect the window area information, and the window area information is an area defined by touched links, as the links are touched by the user.

13. The terminal according to claim 9, further comprising a navigation unit for providing the control unit with audio and video signals for vehicle navigation.

14. The terminal according to claim 9, further comprising a contents interface unit for providing the control unit with external audio and video signals.

15. The terminal according to claim 9, further comprising an IR receive unit for providing the control unit with remote control signals provided by an external remote controller.

16. The terminal according to claim 9, further comprising a wireless transmit-receive unit placed between an external antenna and the control unit.

17. The terminal according to claim 9, further comprising a key input unit for providing the control unit with key input signals corresponding to user's handling.
